(19) United States
(12) Patent Application Publication
(10) Pub. No.: US 2022/0252111 A1
(43) Pub. Date: Aug. 11, 2022

(54) Electromechanical Transmission and/or Clutch Actuator

(71) Applicant: KNORR-BREMSE Systeme fuer Nutzfahrzeuge GmbH, Muenchen (DE)

(72) Inventors: Juergen SCHUDY, Vierkirchen (DE); Sebastian SCHALLER, Langweid (DE); Steffen GROESSL, Muenchen (DE)

(21) Appl. No.: 17/625,458

(22) PCT Filed: Jul. 8, 2020
(86) PCT No.: PCT/EP2020/069200

§ 371 Date: Jan. 7, 2022

(30) Foreign Application Priority Data
Jul. 9, 2019 (DE) 10 2019 118 473.8

(51) Int. Cl. F16D 23/12; F16D 28/00; F16H 25/22; F16H 7/12

(52) U.S. Cl. CPC F16D 23/12; F16D 28/00; F16H 2025/2096; F16H 7/1245; F16D 2023/123; F16H 25/2204

(57) ABSTRACT

An electromechanical transmission and/or clutch actuator includes an electric motor for generating a driving rotational movement of a motor shaft, and elements for transmitting the driving rotational movement via a flexible drive from the electric motor to a spindle drive configured to convert the rotational movement to an axial actuation movement. The elements for transmitting the driving rotational movement may include a driving element such as a driving pulley or gear connected coaxially to the motor shaft, a driven element wheel such as a driven pulley or gear connected to the spindle drive, and a flexible element such as a drive belt which transfers the driving rotational movement from the motor shaft to the spindle drive.

### BACKGROUND AND SUMMARY OF THE INVENTION

The invention relates to an electromechanical transmission and/or clutch actuator for actuating the shift device of a transmission or for actuating a clutch of a vehicle, in particular utility vehicle, comprising an electric motor for generating a driving rotational movement of a motor shaft, which are converted by transmission means.

The field of use of the invention extends primarily to automotive engineering. For the actuation of a clutch for closing or interrupting a power flow in a drivetrain of a vehicle, use is made of clutch actuators which, upon demand, generate an axial actuating force that is required for this. Aside from conventional fluid-actuated clutch actuators, the electromechanical clutch actuators that are of interest here are increasingly also used. Here, the actuating force is generated by an electric drive, preferably an electric motor. In the context of the electromechanical clutch actuator, this driving movement must be converted into a suitable linear actuating movement for the clutch.

The same also applies analogously to the transmission actuators that are likewise of interest here. A transmission actuator serves for actuating the shift device of a transmission for the purposes of gear selection.

### PRIOR ART

DE 10 2007 010 765 A1 has disclosed an electromechanical clutch actuator that is used for clutch actuation in an automated manual transmission of a vehicle. The clutch actuator comprises an electric motor as a drive, and a spindle drive that interacts with a force store. The spindle drive converts the rotational movement of the electric motor into an axial movement for actuating the clutch, wherein, in the case of this prior art, at least one immobilizing device is provided for blocking the spindle drive in order that, in an emergency situation, for example in the event of failure of the on-board electrical system of the vehicle, a clutch actuation can be ensured even in this situation through corresponding activation of the immobilizing device. In the case of this clutch actuator, the electric motor is arranged coaxially with respect to the spindle drive. Situated in between is the abovementioned immobilizing device, which may for example be configured as a spring pressure brake.

Although this electromechanical clutch actuator ensures a compact structural form owing to the coaxial construction, the actuating force that it can generate is substantially dependent on the speed ratio of the spindle drive and on the parameters of the electric motor such as rotational speed and nominal torque. Therefore, this design also limits the usage possibilities of, and the actuating force that can be generated by, the electromechanical transmission and/or clutch actuator.

DE 10 2004 030 005 B4 discloses an electromechanical clutch actuator for a vehicle, which electromechanical clutch actuator, by contrast to the prior art discussed above, has an additional transmission means between the electric motor and the spindle drive. The transmission means serve for stepping down the rotational movement of the motor shaft in order to thus realize a form of preliminary speed ratio that no longer has to be imparted by the spindle drive. The spindle drive can thus be designed with a lower speed ratio in relation to a variant without a transmission.

In the case of this prior art, the transmission means are configured as a single-stage spur gear transmission. Although high drive forces can be transmitted owing to the interaction of the driving toothed gear with the driven toothed gear, narrow manufacturing tolerances must be adhered to for this purpose, in particular with regard to the shaft spacing between motor shaft and spindle drive, in order that optimum tooth meshing is ensured. Owing to the desired compact construction, the diameter of the toothed gears should be as small as possible, whereas the speed ratio should be as high as possible. This conflict of aims has the effect that the drive torque must be transmitted via a driving toothed gear with a very small number of teeth, wherein the maximum possible contact pressure in the tooth meshing must be allowed for in the design in order to avoid the risk of tooth breakage. Furthermore, oil lubrication of the spur gear stage is normally necessary in order to reduce the friction in the rolling of the tooth flanks. This leads to stringent sealing demands on the overall system, and to additional outlay for lubrication.

EP 1 528 277 B1 discloses a further electromechanical clutch actuator with high actuating force. For this, a multi-stage spur gear transmission is used between an electric motor and a linear actuating unit, which in this case is configured as a cam drive.

By contrast to these, it is the object of the present invention to create an electromechanical transmission and/or clutch actuator which, using robust and space-saving transmission means, generates a sufficiently high actuating force for a shift device or a clutch.

### DISCLOSURE OF THE INVENTION

The object is achieved proceeding from an electromechanical transmission and/or clutch actuator having an electric motor for generating a driving rotational movement of a motor shaft, the electromechanical transmission and/or clutch actuator being configured as a traction mechanism drive in which a driving pulley fastened coaxially to the motor shaft of the electric motor is connected via a traction mechanism to a driven pulley. The invention includes a utility vehicle comprising such an electromechanical transmission and/or clutch.

The invention encompasses the technical teaching that the transmission means are configured as a traction mechanism drive in which a driving pulley that is fastened coaxially to the motor shaft of the electric motor is connected via a traction mechanism to a driven pulley, which is preferably fastened coaxially to a spindle drive for converting the driving rotational movement into a linear actuating movement.

In the context of the present invention, as a traction mechanism drive, use is preferably made of a form-fitting traction mechanism drive, the traction mechanism of which thus interacts in form-fitting fashion with toothed pulleys, for example a toothed chain mechanism and in particular a toothed belt mechanism. In the course of the development of the transmission and/or clutch actuator according to the invention, it has been found that it is not imperatively necessary to use toothed gears as transmission means for transferring the rotational movement from the motor shaft to the spindle drive. This is because, if a preferably form-fitting traction mechanism drive is used in conjunction with an upstream of a spindle drive, it is thus possible overall to generate a sufficiently high actuating force for a clutch in a space-saving manner.

In a preferred embodiment, the driven pulley of the form-fitting traction mechanism drive is fastened coaxially to a spindle nut of the spindle drive. Since the spindle nut generally has a greater outer diameter than a motor shaft, the larger of the two pulleys, that is to say the driven pulley, can also be arranged in space-saving fashion around the spindle nut. As an alternative to this, it is also possible for the driven pulley to be fastened to the spindle nut at an end side.

The form-fitting traction mechanism drive, which is preferably configured as a toothed belt mechanism, must be equipped with a toothed belt that exhibits adequate tensile strength for the use to which the invention relates. For this purpose, use is made for example of a reinforced polyurethane belt. The reinforcement of the polyurethane belt may be generated here in the form of an inlay or outer lining composed of a textile fabric material, flexible steel material or the like. The toothing of the toothed belt is in form-fitting engagement, in a manner known per se, with a corresponding toothing on the driving and on the driven pulley. Such a toothed belt is distinguished by a low inherent mass, a large wrap angle, lubrication-free operation and minimal elongation over the service life.

A further contribution to a reduction in weight can be achieved by virtue of the driving pulley and the driven pulley being composed of a plastic, for example polyamide, which can be processed to generate the pulley geometry in a simple manner in terms of manufacturing, for example by injection molding. Aside from this, it is also conceivable to produce the pulleys from a metal, in particular a light metal, for example in the form of a sintered aluminum part.

In a preferred embodiment of the invention, it is proposed that the motor shaft of the electric motor runs so as to be spaced apart in parallel with respect to the main axis of the spindle drive, and that the traction mechanism drive bridges the spacing A hereby formed such that this component combination results in a substantially U-shaped side view. In other words, the electric motor is thus arranged parallel and adjacent to the spindle drive, and the traction mechanism drive that bridges the spacing is positioned at the same end side of both components, resulting overall in a compact structural form of the transmission and/or clutch actuator.

As an alternative to this, it is however also possible for the motor shaft of the electric motor to run so as to be spaced apart at an angle with respect to, and adjacent to, the main axis of the spindle drive, and for the traction mechanism drive to bridge the spacing hereby formed such that this component combination results overall in a substantially Z-shaped side view.

As a further measure that improves the invention, it is proposed that adjustment means for setting the spacing A between motor shaft and spindle drive are provided, which adjustment means are arranged at the electric motor or at the spindle drive in order to adjust the pretension of the toothed belt. Such an adjustment can hereby be performed easily during the course of the installation of the transmission and/or clutch actuator, and a readjustment for length compensation is also easily possible at maintenance intervals provided for this purpose, such that it is possible to achieve a maximum service life of the toothed belt before this possibly has to be exchanged.

The toothed belt may additionally be combined with a spring-loaded tensioning roller unit known per se, which permanently imparts a pretension to the toothed belt, and hereby compensates elongation, during operation.

In a preferred embodiment, the spindle drive is configured in the form of a ball screw spindle, which is distinguished by a low-friction conversion of the driving rotational movement into a linear movement for actuating the clutch. As an alternative to this, it is however also possible, depending on the design constraints of the usage situation, to use a simple threaded spindle, which may for example be configured as a trapezoidal threaded spindle.

Further measures that improve the invention will be illustrated in more detail below together with the description of a preferred exemplary embodiment of the invention on the basis of the figures.

### BRIEF DESCRIPTION OF THE DRAWINGS

FIG. 1 shows a schematic side view of an electromechanical clutch actuator in accordance with an embodiment of the present invention,

FIG. 2 shows a plan view of the transmission of the clutch actuator as per FIG. 1, and

FIG. 3 shows a plan view of the transmission of an alternative embodiment of the clutch actuator of the present invention.

### DETAILED DESCRIPTION OF THE DRAWINGS

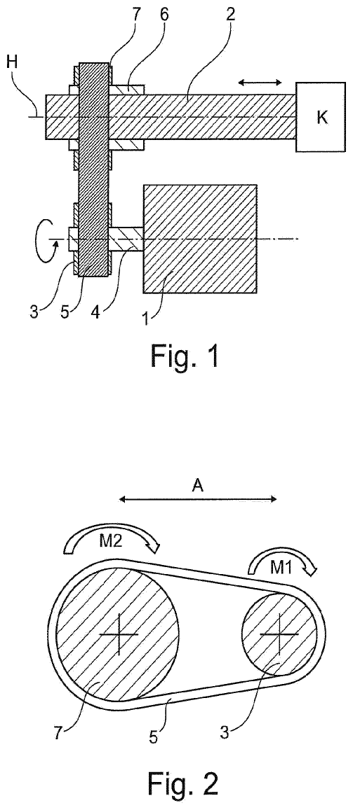

According to FIG. 1, an electromechanical clutch actuator for actuating a merely schematically indicated clutch K of a vehicle—not illustrated in any more detail here—is composed substantially of an electric motor 1 for generating a driving rotational movement, which is transmitted to a spindle drive 2 for converting said driving rotational movement into an axial movement for clutch actuation.

A traction mechanism drive for stepping down the drive-side rotational movement is provided between the electric motor 1 and the spindle drive 2. The traction mechanism drive comprises a driving pulley 3, which is fixed to a motor shaft 4 of the electric motor 1, and a toothed belt 5 which is tensioned on said driving pulley and which corresponds with a driven pulley 7 which is fastened to a spindle nut 6 of the spindle drive 2. The driven pulley 7 is situated at the same level as the driving pulley 3. In this exemplary embodiment, the driven pulley 7 surrounds the spindle nut 6, which in a manner known per se corresponds with the spindle part of the spindle drive 2 via a screw drive.

Altogether, this results in a structural form in which the motor shaft 4 of the electric motor 1 runs so as to be spaced apart in parallel with respect to, and adjacent to, the main axis H of the spindle drive 2. Here, the traction mechanism drive bridges the spacing A hereby formed such that this component combination results in a substantially U-shaped side view.

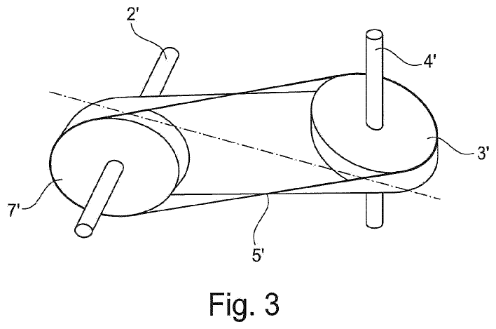

According to FIG. 2, the driving pulley 3 and the driven pulley 7 are dimensioned such that the number of teeth respectively situated on said pulleys results in a specified step-down speed ratio between the torque M1 of the electric motor 1—not illustrated in any more detail here—and the torque M2 of the spindle drive—likewise not illustrated in any more detail here. Here, the length of the toothed belt 5 is such that the latter bridges the spacing A whilst ensuring the form-fitting tooth meshing.

In the alternative exemplary embodiment shown in FIG. 3, the motor shaft 4′ is arranged so as to be spaced apart at an angle with respect to, and adjacent to, the main axis of the spindle drive 2′. The hereby twisted toothed belt 5′ bridges the spacing between the driving pulley 3′ and the driven pulley 7′ such that this component combination results overall in a substantially Z-shaped side view.

The invention is not restricted to the preferred exemplary embodiment described above. Modifications or additions may also be made which are also encompassed by the scope of protection of the following claims. For example, it is also possible for the spacing A between the electric motor 1 and the spindle drive 2 to be made adjustable for the purposes of adjusting the pretension of the toothed belt 5. For example, a carriage guide with a clamping screw mechanism or the like could be used for this purpose. Likewise, the toothed belt 5 may if necessary be equipped with a spring-loaded tensioning roller means for the purposes of compensating elongation.

### LIST OF REFERENCE DESIGNATIONS

1 Electric motor
2 Spindle drive
3 Driving pulley
4 Motor shaft
5 Toothed belt
6 Spindle nut
7 Driven pulley
A Spacing
K Clutch
H Main axis
M1 Torque at electric motor
M2 Torque at spindle drive

1-12. (canceled)

13. An electromechanical transmission and/or clutch actuator, comprising:
an electric motor having a motor shaft; and
a traction mechanism drive having a driving pulley and a driven pulley,
wherein
the driving pulley is arranged coaxially on the motor shaft of the electric motor, and
rotational movement of the motor shaft is transferable from the driving pulley to the driven pulley by a traction mechanism.

14. The electromechanical transmission and/or clutch actuator as claimed in claim 13, further comprising:
a spindle drive,
wherein
the driven pulley is arranged coaxially on the spindle drive, and
the rotational movement transmitted by the traction mechanism drive drives the spindle drive via the driven pulley to convert the rotational movement into an axial clutch actuation movement.

15. The electromechanical transmission and/or clutch actuator as claimed in claim 14, wherein
the driven pulley is arranged with a spindle nut of the spindle drive such that the driven pulley surrounds the spindle nut or is arranged at an end side of the spindle nut.

16. The electromechanical transmission and/or clutch actuator as claimed in claim 13, wherein
the traction mechanism is a form-fitting traction mechanism.

17. The electromechanical transmission and/or clutch actuator as claimed in claim 16, wherein
the form-fitting traction mechanism includes a toothed belt.

18. The electromechanical transmission and/or clutch actuator as claimed in claim 13, wherein
the driving pulley and the driven pulley are composed of an injection molded plastic.

19. The electromechanical transmission and/or clutch actuator as claimed in claim 13, wherein
the motor shaft of the electric motor is spaced apart in parallel from a main axis of the spindle drive,
the traction mechanism drive bridges the spacing between the motor shaft and the main axis of the spindle drive, and
the motor shaft, the main axis of the spindle drive and the traction mechanism drive are arranged with a substantially U-shaped side view.

20. The electromechanical transmission and/or clutch actuator as claimed in claim 13, wherein
the motor shaft of the electric motor is spaced apart at an angle from the main axis of the spindle drive, and
the motor shaft, the main axis of the spindle drive and the traction mechanism drive are arranged with a substantially Z-shaped side view.

21. The electromechanical transmission and/or clutch actuator as claimed in claim 17, further comprising:
an adjustment arrangement configured to permit setting a variable spacing between motor shaft and spindle drive,
wherein the adjustment arrangement is configured to adjust a pretension of the toothed belt.

22. The electromechanical transmission and/or clutch actuator as claimed in claim 21, wherein
the adjustment arrangement includes a spring-loaded tensioning roller configured to pretension the toothed belt.

23. The electromechanical transmission and/or clutch actuator as claimed in claim 14, wherein
the spindle drive includes a ball screw spindle.

24. A utility vehicle, comprising:
a transmission or clutch which is incorporated into a power flow of a drivetrain; and
an electromechanical transmission and/or clutch actuator configured to actuate the transmission for clutch, the electromechanical transmission and/or clutch actuator having an electric motor having a motor shaft and a traction mechanism drive having a driving pulley and a driven pulley, wherein the driving pulley is arranged coaxially on the motor shaft of the electric motor, and rotational movement of the motor shaft is transferable from the driving pulley to the driven pulley by a traction mechanism.
